(19) United States
(12) Patent Application Publication
(10) Pub. No.: US 2023/0054109 A1
(43) Pub. Date: Feb. 23, 2023

(54) METHOD AND APPARATUS FOR RECONFIGURING AN AUTONOMOUS VEHICLE IN THE EVENT OF A FAULT

(71) Applicant: Volkswagen Aktiengesellschaft, Wolfsburg (DE)

(72) Inventors: Tobias Kain, Wolfsburg (DE); Maximilian Wesche, Edemissen (DE); Julian-Steffen Müller, Hannover (DE); Hendrik Decke, Braunschweig (DE)

(21) Appl. No.: 17/793,343

(22) PCT Filed: Jan. 12, 2021
(86) PCT No.: PCT/EP2021/050494

§ 371 Date: Jul. 15, 2022

(30) Foreign Application Priority Data
Jan. 15, 2020 (DE) 10 2020 200459.5
Mar. 17, 2020 (DE) 10 2020 203420.6

(51) Int. Cl. B60W 50/02; G06F 11/20; G06F 11/30

(52) U.S. Cl. CPC B60W 50/0225; G06F 11/2028; G06F 11/3013

(57) ABSTRACT

Technologies and techniques for reconfiguring an autonomous vehicle in the event of a fault, wherein application entities are executed in a distributed manner across a plurality of computing nodes in accordance with a predefined configuration. A fault in an application entity and/or in an operating system and/or in a piece of hardware is detected via the at least one monitor device, wherein the detected fault is isolated via a switching device by switching to application entities which are redundant with respect to the affected application entities, and wherein predefined redundancy conditions and/or segregation conditions are restored for the application entities by the reconfiguration, by an application placement device of the configuration, wherein the reconfiguration is carried out such that the number of times application entities are switched to other computing nodes to establish the predefined redundancy conditions and/or segregation conditions will be or is minimized.

### RELATED APPLICATIONS

The present application claims priority to International Patent App. No. PCT/EP2021/050494 to Kain, et al., titled “Method and Apparatus for Reconfiguring an Autonomous Vehicle in The Event of a Fault”, filed Jan. 12, 2021, which claims priority to German Patent App. No. 10 2020 200 459.5, filed on Jan. 15, 2020 and German Patent App. No. 10 2020 203 420.6, filed on Mar. 17, 2020, the contents of each being incorporated by reference in their entirety herein.

### TECHNICAL FIELD

The present disclosure relates to a method and apparatus for reconfiguring an autonomous vehicle in the event of a fault. The present disclosure also relates to a vehicle with such a device.

### BACKGROUND

Modern machines have an ever-increasing number of technical components that interact with one another. In order to ensure continued operation even in the event of a fault in one or more of these components, the FDIR (Fault, Detection, Isolation, Recovery) method is known from the field of aviation. Here, errors are recognized by monitoring. A detected fault is then isolated by switching from an affected component to a redundant component with the same functionality that is held in readiness. After switching, an attempt is made to restore redundancy by activating additional components. So far, however, a human fallback level has always been available that can manually take over control if the method fails.

### SUMMARY

The present disclosure is based on aspects of creating a method and a device for reconfiguring an autonomous vehicle in the event of a fault, with which operation can be maintained in an improved manner even without a human fallback level.

These objects are achieved according to the independent claims disclosed herein. Advantageous refinements of the present disclosure result from any and/or all of the dependent claims.

In some examples, a method is disclosed for reconfiguring an autonomous vehicle in the event of a fault, with application entities being carried out according to a predefined configuration, and distributed across a number of computing nodes. At least some of the application entities recording sensor data are fed to at least one sensor and at least some of the application entities generate and provide control signals for controlling the vehicle. The application entities and/or operating systems and/or hardware corresponding to the computing nodes are monitored using at least one monitor device, and a fault in an application entity and/or in an operating system and/or in hardware may be detected via the at least one monitor device. The detected error device may be isolated by switching to application entities that are redundant to the respective application entities concerned, via a switching device, and wherein for the application entities predetermined redundancy conditions and/or segregation conditions are restored by reconfiguring the configuration via an application placement device. The reconfiguration may be configured in such a way that a number of shifts from application entities to other computing nodes necessary to establish the predefined redundancy conditions and/or segregation conditions becomes minimized or is minimized.

In some examples, a device is disclosed for reconfiguring an autonomous vehicle in the event of a fault is created, with application entities being carried out in the vehicle according to a predetermined configuration distributed over a number of computing nodes, with at least some of the application entities being fed with acquired sensor data from at least one sensor and with at least from part of the application entities. Control signals for controlling the vehicle are generated and provided, comprising at least one monitor device, a switching device, and an application placement device, wherein the at least one monitor device is configured to monitor the application entities and/or operating systems and/or hardware corresponding to the computing nodes monitor and detect a fault in an application entity and/or in an operating system and/or in hardware. The switching device may be configured to isolate the detected error by switching to application entities that are redundant to the respective application entities concerned, via a switching device. The application placement device may be configured to restore redundancy conditions and/or segregation conditions predetermined for the application entities by reconfiguring the configuration, and implementing the reconfiguration in such a way that a number of shifts from application entities to other computing nodes necessary to establish the specified redundancy conditions and/or segregation conditions is minimized.

Further features for configurations of the device result from the description of configurations of the method. The advantages of the device are in each case the same as in the embodiments of the method disclosed herein.

Furthermore, an associated vehicle is also disclosed, comprising at least one device according to one of the described examples.

### BRIEF DESCRIPTION OF THE DRAWINGS

Aspects of the present disclosure are explained in more detail below with reference to the figures. These show:

FIG. 1 illustrates a schematic representation of an embodiment of the device for reconfiguring an autonomous vehicle in the event of a fault, under some aspects of the present disclosure;

FIGS. 2a to 2c illustrates a schematic representation of configurations under some aspects of the present disclosure;

FIG. 3 illustrates a schematic representation of an embodiment of the method for reconfiguring an autonomous vehicle in the event of a fault under some aspects of the present disclosure;

FIG. 4 illustrates a schematic representation of a configuration calculated after the occurrence of a fault with insufficient resources under some aspects of the present disclosure; and

FIG. 5 illustrates a schematic representation of a further embodiment of the method under some aspects of the present disclosure.

### DETAILED DESCRIPTION

In examples provided herein, the disclosed methods and devices make it possible to maintain an operation or an automated drive of the vehicle without the presence of a human fallback level after the occurrence of a fault in one or more application entities. The reconfiguration takes place in such a way that a number of shifts from application entities to other computing nodes necessary to establish the specified redundancy conditions and/or segregation conditions is minimized. Since each individual shift of an application entity requires both time and resources (computing resources and memory resources) and, furthermore, under some circumstances redundancy conditions and/or segregation conditions may not be fulfilled for a period of the shift, each shift is safety-critical and should therefore be avoided if possible. For example, based on a current active configuration, as well as the specific parameters of the application entities and the computing nodes, the application placement device attempts to calculate a new configuration that fulfills the redundancy conditions and/or segregation conditions, the configuration being calculated in such a way that to activate the new configuration, as few application entities as possible have to be shifted to other computing nodes. To this end, the application placement device solves, in particular, an application placement problem.

One advantage of the method and the device is that the reconfiguration of the automated driving vehicle is implemented in such a way that a number and duration of safety-critical shifts of application entities during reconfiguration is minimized.

In some examples, an application may be provided using at least one application entity. An application entity may be considered a process that provides a specific functionality and is executed on at least one computing node. For example, an application entity can provide one of the following functionalities in connection with automated driving: environment perception, localization, navigation, trajectory planner or a prognosis of one's own behavior and/or the behavior of objects in the vicinity of the vehicle, etc. For this purpose, at least some of the application entities receive sensor data that were detected by means of at least one sensor and/or data from other application entities. At least some of the application entities provide control signals for the vehicle. The application entities can be in an active and in at least one passive operating state. In the active operating state, the application entity has a direct influence on the control of the vehicle. In at least one passive operating state, however, an application entity runs redundantly next to an active application entity of the same type, receives the same input data and generates the same output data or control signals, but has no influence on the control of the vehicle. Different levels of the passive state can be provided, which differ, for example, only in how quickly a passive application entity can be transferred to the active operating state. In the context of the method, both the active and the passive application entities may be. In the event of a fault affecting passive application entities, the method can then be carried out accordingly, isolating and switching being omitted and an affected passive application entity being merely terminated and replaced by a newly started passive application entity with the same functionality, so that redundancy conditions are restored.

In some examples, a configuration may include an assignment of active and passive application entities to individual computing nodes. The configuration may specify which application entity is executed on which computing node, as well as the respective associated operating states of the application entities. The configuration may be dependent on predefined redundancy conditions and/or segregation conditions, which were determined or are determined as a function of the functionalities of the application entities. For example, it can be provided that the redundancy condition prescribes simple redundancy. An active application entity and a passive application entity are then operated for an application or a functionality. Depending on the application scenario, different redundancy conditions can be provided for the same functionalities, e.g., single (e.g., pedestrian detection on a motorway) or multiple redundancy (e.g., quadruple redundancy for pedestrian detection in a play street).

A segregation condition may be configured as a specification for a number of different computing nodes on which an application should be executed by means of redundant application entities. In some examples, a segregation condition can affect both software and hardware. For example, a segregation condition can include the fact that redundant application entities of an application must each be executed on a predetermined number of different operating systems. Furthermore, for example, a segregation condition can include that redundant application entities of an application must be executed separately from one another on a predetermined number of different computing nodes.

The vehicle disclosed herein may be configured as a motor vehicle. However, it should be understood that the vehicle can also be configured as any land, water, air, rail or space vehicle.

In some examples, a monitoring device may be used for each application entity. Furthermore, a monitor device may be used for each operating system and/or each hardware. As a result, monitoring can be carried out more reliably and more quickly, so that a fault can be detected more quickly.

Parts of the device, such as the at least one monitor device, the switching device and/or the application placement device, can be designed individually or collectively as a combination of hardware and software, for example as program code that is executed on a microcontroller or microprocessor. However, it can also be provided that parts are designed individually or combined as an application-specific integrated circuit (ASIC).

In some examples, the application entities may be assigned a priority class, with configurations for subsets that are formed from application entities of at least one of the assigned priority classes being calculated individually for reconfiguration. This makes it possible to adapt a configuration or to reconfigure the vehicle even if, after a fault has occurred, there are no longer enough resources (e.g., due to defective computing nodes etc.) available for all previously active applications or application entities. The prioritization of the application entities using the priority classes then makes it possible in particular to calculate configurations for the different priority classes individually and thereby ensure or enable continued operation of the autonomous vehicle, albeit with possibly a reduced scope of functions. The priority classes are, for example, a measure of how important or security-relevant an application entity classified as a result is. The priority classes can include, for example, the following four classes: HIGHEST, HIGH, LOW, LOWEST. In principle, however, more or fewer priority classes can also be provided. The configuration is calculated, for example, using one of the following methods: integer linear programming, evolutionary game theory, or reinforcement learning.

In some examples, the subsets may be formed in such a way that the subsets successively include only application entities whose assigned priority classes reach a respective minimum priority class. As a result, a priority of the priority classes comprised by subsets can be successively increased. Application instances to which a priority class is assigned that is below a predetermined minimum priority class are not included in a subset considered. This makes it possible to prioritize when calculating the configurations for the subsets. Based on the priority classes mentioned above, for example, the following four subsets (S₁ to S₄) can be formed, with different minimum priority classes being used for each of the subsets:

S₁=HIGHEST υ HIGH υ LOW υ LOWEST,

S₂=HIGHEST υ HIGH υ LOW,

S₃=HIGHEST υ HIGH,

S₄=HIGHEST.

A configuration can now be calculated for each of these subsets by means of the application placement device. If no configuration can be calculated for one of the subsets, for example because there is no solution, solutions for configurations of the other subsets can be used.

In some examples, the configurations for the subsets may be calculated at least partially parallel to one another using the application placement device. The configurations for the subsets may be all calculated parallel to one another using the application placement device. After all (or some) of the computation processes running in parallel have been completed, the application placement device selects the best solution and reconfigures the vehicle. In this case, a solution is preferred from that subset which includes most of the subsets with the highest priority classes. For the subsets S₁ to S₄ described above by way of example, this means that a successfully calculated configuration for the subset S₃ is preferred over a successfully calculated configuration for the subset S₄. Accordingly, a configuration for S₁ is preferred over a configuration of S₂, S₃ and S₄ etc. Only if no configuration could be calculated for a subset and no configuration could be calculated for a subset that is higher in terms of the priority classes included, is a configuration selected for a lower-priority subset and implemented by reconfiguring.

In some examples, the configurations for the subsets are at least partially calculated sequentially using the application placement device. The configurations for the subsets may be all calculated sequentially using the application placement device. This has the advantage that the entire computing resources for calculating a configuration can be made available for a single subset, so that computing time can be reduced, in particular minimized.

In some examples, the configurations are first calculated for those subsets which in each case comprise the largest number of highest priority classes. This does not allow any kind of ranking to be established. For the subsets defined above, this would mean that the configurations for the subsets are calculated one after the other in the following order: S₁, S₂, S₃, S₄. For example, the configuration for a subsequent subset is calculated only if a calculation for a subset under consideration has not led to success, that is, if no solution for a configuration could be found for the subset under consideration.

In some examples, the calculation is aborted when a predetermined maximum calculation time is reached or exceeded, whereby that configuration already calculated that includes application entities with the largest number of highest priority classes in each case is selected for reconfiguration. This has the advantage that time specifications can be met. Even if an (overall) optimal solution cannot be found, at least one solution can be found and made available for reconfiguration. Specifying the maximum calculation time makes it possible to define a response time when a fault occurs within which the calculation or the reconfiguration must be carried out. This allows in particular safety requirements with regard to time-critical processes or time-critical application entities to be met.

In principle, this example can be used both in a parallel and in a sequential calculation. In the case of a parallel calculation, it can generally be assumed that a calculation time for the subsets with the smallest number of application entities is the shortest. Therefore, in the case of calculation processes carried out in parallel, the calculation processes for such subsets will be completed first. Since with the more complex calculation processes for the other subsets gradually being completed over time, improved solutions for configurations also successively become available. If the maximum calculation time is reached, the calculation processes that are still running are stopped and the best of the existing solutions for a configuration is selected and used when reconfiguring.

In the case of a sequential calculation, the configurations for the subsets with the lowest number of highest priority classes may be calculated first (in the above example, the sequential calculation would therefore be in the order: S₄, S₃, S₂, S₁ respectively). After the specified calculation time has elapsed, the best available configuration is selected, that is, the one that includes the greatest number of highest priority classes.

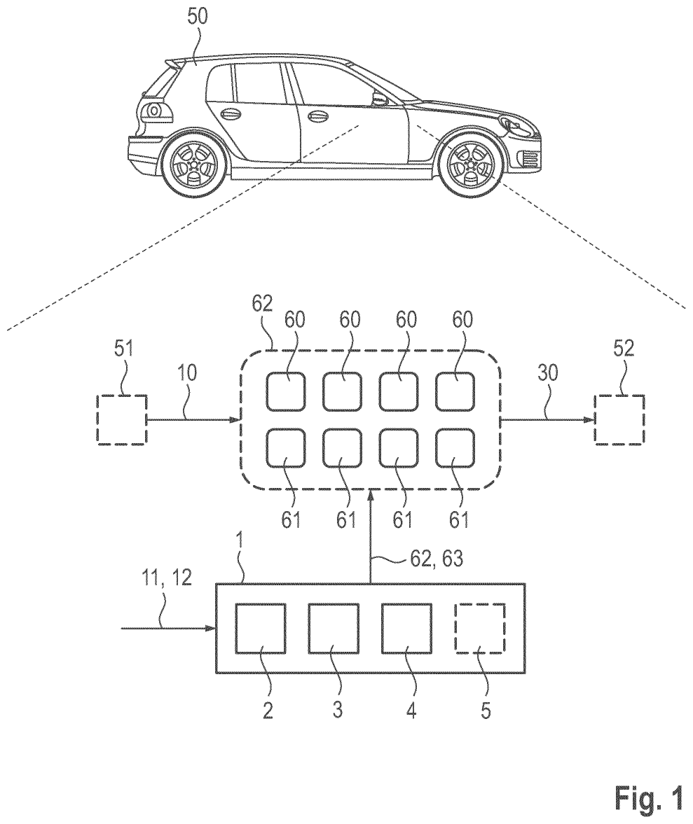

Turning to FIG. 1, the drawing shows a schematic representation of an embodiment of the device 1 for reconfiguring an autonomous vehicle 50 in the event of a fault.

In the vehicle 50, application entities 60, 61 are executed distributively over a number of computing nodes in accordance with a predetermined configuration 62. The application entities 60, 61 provide, for example, functionality for perception of the surroundings, localization, navigation and/or trajectory planning. At least some of the application entities 60, 61 are supplied with detected sensor data 10 to at least one sensor 51 of the vehicle 50 (or other sensors, for example, which sense the surroundings of the vehicle 50). At least some of the application entities 60, 61 generate and provide control signals 30 for controlling the vehicle 50. The control signals 30 provided of the respectively active application entities 60 are fed to an actuator 52 of the vehicle 50, which implements an automated driving of the vehicle 50.

The device 1 comprises a monitor device 2, a switching device 3 and an application placement device 4. In this example, a monitor device 2 is provided for each of the application entities 60, 61, for each operating system and for each hardware providing the computing nodes (for the sake of clarity only one monitor device 2 shown). Parts of the device 1 can be designed individually or collectively as a combination of hardware and software, for example as program code that is executed on a microcontroller or microprocessor. It can also be provided that the provision of a functionality of the application entities 60, 61 and the device 1 takes place jointly, for example by means of a data processing device of the vehicle 50.

The application entities 60, 61 and/or operating systems and/or hardware corresponding to the computing nodes are monitored by the monitoring device 2. The monitoring device 2 detects faults in the application entities 60, 61 and/or the operating systems and/or in the hardware.

If a fault is detected, the fault detected is isolated by means of the switching device 3 by switching to passive application entities 61, which are redundant to the application entities 60 affected by the error. To this end, the switching device 3 activates the respective redundant passive application entity 61, which takes over the functionality of the application entity 60 affected by the fault, while the affected application entity 60 is deactivated. This takes place, for example, using a switching signal 63. If several application entities 60 are affected, the respective redundant passive application entities 61 are activated accordingly.

Once the switchover has taken place, predetermined redundancy conditions 11 and/or segregation conditions 12 for the application entities 60, 61 are restored by reconfiguring the configuration 62 using the application placement device 4.

The redundancy conditions 11 include, for example, specifications as to which application entity 60 should or must be operated with which redundancy (none, single, double, multiple). The reconfigured configuration 62 is set by configuring the application entities 60, 61 accordingly. The reconfiguration here includes, in particular, starting and setting up further passive application entities 61 in order to (again) fulfill a respective redundancy condition 11 and/or segregation condition 12. If a previously passive application entity 61 is activated for required redundancy due to a fault and a previously active application entity 60 is deactivated for isolation, a new passive application entity 61 is set up and started on one of the computing nodes so that the redundancy is restored. If there are several application entities 60 to be isolated, the procedure is corresponding.

In this case, the reconfiguration is carried out in such a way that a number of necessary shifts from application entities 60, 61 to other computing nodes for establishing the predetermined redundancy conditions 11 and/or Segregation conditions 12 is minimized or has been minimized.

In some examples, the device 1 may include a fail-safe device 5. The vehicle 50 can be transferred to a safe state by means of the fail-safe device 5 if at least one specified redundancy condition 11 can no longer be met due to the reconfiguration or at least one segregation condition 12 cannot (can no longer) be fulfilled. This is the case, for example, when the fault means that there are no longer enough resources (e.g., computing power, memory, etc.) available for the safety-relevant application entities 60, 61. The vehicle 50 is then driven to the edge of the road, for example, by the fail-safe device 5, and is parked, with autonomous further travel being blocked.

The procedure of the application placement device 4 when calculating a configuration 62 is described below by way of example. As already described, the application placement device 4 is responsible for placing application entities 60, 61 so that the specified redundancy conditions 11 and/or segregation conditions 12 can be restored. For this purpose, the application placement device 4 attempts to find computing nodes that have sufficient resources (in particular computing power, memory and installed software) to be able to execute new application entities 60, 61 so that an isolated application entity 60, 61 can be replaced. If there are insufficient resources available, the application placement device 4 can stop application entities 60, 61 with lower priority in order to be able to provide resources for an application entity 60, 61 with higher priority.

In the following example, an application placement problem is solved using the integer linear programming method.

First, the application placement problem is formulated. For this purpose, the following parameters are extracted from a current state of the vehicle and the newly started application entity(s) 60, 61. These parameters are then fed to a solver for the application placement problem as input parameters:
I: The set of application entities 60, 61 to be placed.
A: The set of applications, where ∀a∈A: a≤I. Furthermore, the following must apply: ∀a₁∈.

A,∀a₂∈A,a₁≠a₂:a₁∩a₂=Ø.
N: set of computing nodes.
C*: configuration matrix which describes the current configuration or the currently active placement, where C*_{i,n}=1, if i∈I is carried out by n∈N; otherwise C*_{i,n}=0. It should be noted that for each new application entity i_{new,n}∈I, for example application entities that are intended to restore the redundancy conditions that existed before the error occurred, the following applies: ∀n∈N: C*i_{new,n}=0.
R. The placement boundary matrix, where R_{I,n}=1 if n∈N satisfies all software conditions of I e I; otherwise R_{i,n}=0.
Φₙ: The storage capacity of n e N.
Ωₙ: The computing capacity of n e N.
Φᵢ: The memory requirements of I e I.
ωᵢ: The memory requirements of I e I.
πₐ: The minimum number of computing nodes on which a e A must be executed, i.e. the segregation condition with regard to hardware.

On the basis of these parameters, the application placement device 4 calculates a new configuration matrix C, where Cᵢₙ, =1, if I e I is to be executed on ne N; otherwise Cᵢₙ, =0. Hence there exist 2^{|I|*|N|} potential solutions. However, not all of these solutions are valid. To define the conditions that make a configuration valid, five linear boundary conditions are defined below:

### Boundary Condition 1:

An application entity 60, 61 must be executed by exactly one computing node:

$$∀ i ∈ I : {\sum }_{n ∈ N} {C}_{i , n} = 1 .$$

### Boundary Condition 2:

The sum of the memory demand of all application entities 60, 61 that are executed on a computing node must not exceed the memory capacity of this computing node:

$$∀ n ∈ N : {\sum }_{i ∈ I} ( {ϕ}_{i} * {C}_{i , n} ) \leq {Φ}_{n} .$$

### Boundary Condition 3:

The sum of the computing power demand of all application entities 60, 61 that are executed on a computing node must not exceed the computing capacity of this computing node:

$$∀ n ∈ N : {\sum }_{i ∈ I} ( {ω}_{i} * {C}_{i , n} ) \leq {Ω}_{n} .$$

### Boundary Condition 4:

An application entity 60, 61 only runs on a computing device that provides software that is required by the application entity 60, 61:

∀i∈I,∀n∈N:R_{i,n}=0⇒C_{i,n}=0.

### Boundary Condition 5:

The application entities 60, 61 belonging to the same application must run on a minimum number of different computing devices, that is to say the hardware segregation condition must be met for each application. To express this condition in a linear way, a matrix of auxiliary variables h is introduced, which is defined as follows:

$$∀ a ∈ A , ∀ n ∈ N : {h}_{a , n} = \{ \begin{matrix}1 , & {\sum }_{i ∈ a} {C}_{i , n} \geq 1 \\ 0 , & {anderenfalls}_{[ otherwise ]}\end{matrix}$$

With the help of the auxiliary matrix, this condition can be defined using the following linear expressions:

$$∀ a ∈ A , ∀ n ∈ N : {h}_{a , n} = 0 ∨ {h}_{a , n} = 1 \qquad ( Randbedingung 5.1 )$$

$$∀ a ∈ A , ∀ i ∈ a , ∀ n ∈ N : {C}_{i , n} \leq {h}_{a , n} \qquad ( Randbedingung 5.2 )$$

$$∀ a ∈ A , ∀ n ∈ N : {\sum }_{i ∈ a} {C}_{i , n} \geq {h}_{a , n} \qquad ( Randbedingung 5.3 )$$

$$∀ a ∈ A : {\sum }_{n ∈ N} {h}_{a , n} \geq {π}_{a} \qquad ( Randbedingung 5.4 )$$

$$[ Randbedingung = boundary condition ]$$

To illustrate the boundary condition 5, consider the following example. With the assumption of the following input variables and the configuration matrix C, it is shown that boundary condition 5 applies to the application, but not to application a₂.

$$N = \{ {n}_{1} , {n}_{2} , {n}_{3} , {n}_{4} \} , I = \{ {i}_{1} , {i}_{2} , {i}_{3} , {i}_{4} , {i}_{5} , {i}_{6} \}$$

$$A = \{ {a}_{1} , {a}_{2} \} , wobei {a}_{1} = \{ {i}_{1} , {i}_{2} , {i}_{3} \} und {a}_{2} = \{ {i}_{4} , {i}_{5} , {i}_{6} \} ,$$

$${π}_{{a}_{1}} = {π}_{{a}_{2}} = 3 ,$$

$$C = [ \begin{matrix}0 & 1 & 0 & 0 \\ 0 & 0 & 1 & 0 \\ 0 & 0 & 0 & 1 \\ 1 & 0 & 0 & 0 \\ 1 & 0 & 0 & 0 \\ 1 & 0 & 0 & 0\end{matrix} ]$$

First we consider application a₁:
Since Σ_{i∈a}_{₁}C_{i,n}_{₁}=0 boundary condition 5.3 causes that hₐ_{₁}_{,n}_{₁}=0. Furthermore boundary condition 5.2 causes that hₐ_{₁}_{,n}_{₂}=hₐ_{₁}_{,n}_{₃}=hₐ_{₁}_{,n}_{₄}=1, since Cᵢ_{₁}_{,n}_{₂}=Cᵢ_{₂}_{,n}_{₃}=Cᵢ_{₃}_{,n}_{₄}=1.
This means that boundary condition 5.4 also applies, since:

$${\sum }_{n ∈ N} {h}_{{a}_{1} , n} = 3 \geq {π}_{a} = 3 .$$

Next it is shown that boundary condition 5 does not apply to application a₂:

### There

Cᵢ_{₄}_{,n}_{₁}=1 applies
(Note that the following also applies:
:Cᵢ_{₅}_{,n}_{₁}=Cᵢ_{₆}_{,n}_{₁}=1) and boundary condition 5.2 must likewise apply,
There C applies and boundary condition 5.3 apply
hₐ_{₂}_{,n}_{₁}=1
Cᵢ_{ₓ}_{,n}_{_{y}}=0 (x∈{4,5,6} and y∈{2,3,4}) applies and boundary condition 5.3 must apply,
hₐ_{₂}_{,n}_{₂}=hₐ_{₂}_{,n}_{₃}=hₐ_{₂}_{,n}_{₄}=0. applies. This leads to the fact that \ boundary condition 5.4 is not fulfilled,
the following applies:

$${\sum }_{n ∈ N} {h}_{{a}_{2} , n} = 1 ≱ {π}_{a} = 3 .$$

Although the defined boundary conditions limit a solution space, a large number of valid solutions can exist. In order to determine which of the solutions are most preferred, the solver is instructed to find the configuration or placement that maximizes the following optimization criterion:

$${\sum }_{i ∈ I , n ∈ N} {C}_{i , n} \times {C}_{i , n}^{*} .$$

On the basis of this optimization criterion, configurations or application placements are preferred that minimize a number of shifts from application entities 60, 61 to other computing nodes. This objective is pursued since a smaller number of shifts in particular reduces the time required for reconfiguration.

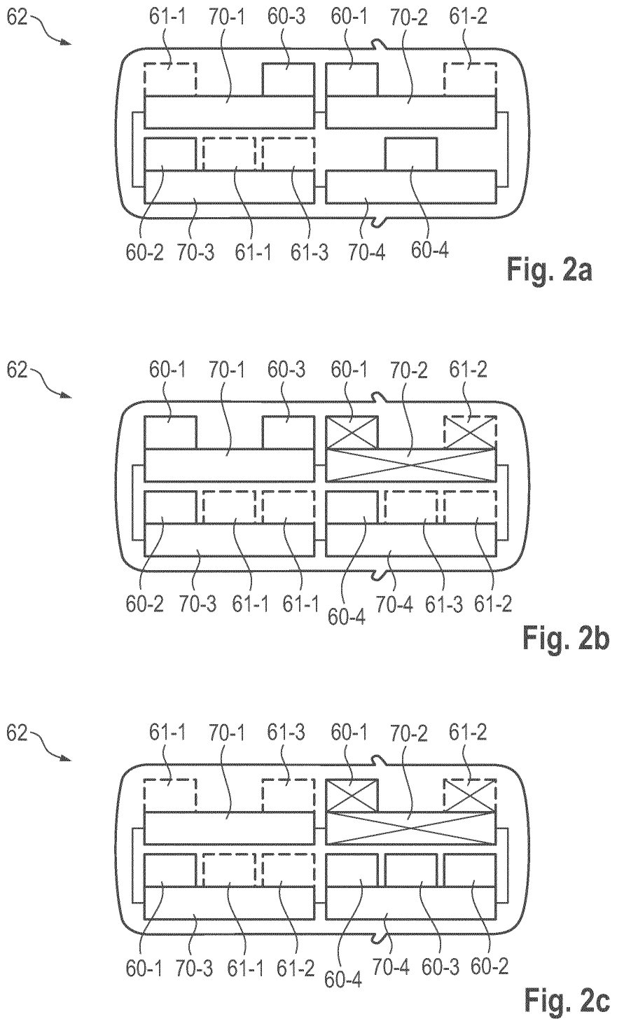

FIGS. 2a, 2b and 2c show schematic representations of configurations 62 to illustrate the method described in this disclosure. FIG. 2a shows an original (initial) configuration 62. FIG. 2b shows a configuration 62 as calculated by the application placement device. FIG. 2c shows a configuration 62 which represents a valid solution to the application placement problem, but which requires a total of five shifts of application entities 60-x.

In the example shown, it is assumed that the configuration 62 comprises four applications, which are provided with the help of the active application entities 60-1, 60-2, 60-3, 60-4 and the redundant passive application entities 61-1, 61-2, 61-3, 61-4, as well as four computing nodes 70-1, 70-2, 70-3, 70-4.

The four applications require the following resources:

| | Application | Application | Application | Application |
|---|---|---|---|---|
| | 1 | 2 | 3 | 4 |
| Memory | 50 | 15 | 15 | 10 |
| requirement | | | | |
| Computing | 30 | 20 | 20 | 10 |
| requirement | | | | |
| Software required | x | x, y | x, z | y, z |
| Hardware | 2 | 2 | 2 | 1 |
| segregation | | | | |

Furthermore, the following resources are provided by the four computing nodes 70-x (abbreviated as “CN” in the table):

| | CN 1 | CN 2 | CN 3 | CN 4 |
|---|---|---|---|---|
| Memory capacity | 70 | 70 | 120 | 40 |
| Computing capacity | 60 | 50 | 100 | 90 |
| Installed software | x, y | x, y | x, y, z | x, y, z |

It is further assumed that, based on the configuration 62 shown in FIG. 2a, the computing node 70-2 has a defect and can no longer be used. This leads to the fact that the application entities 60-1 and 61-2 can no longer be provided either. In this situation, the switching device switches one of the passive application entities 61-1 to the “active” operating state (illustrated by the change in the reference number from 61-1 to 60-1).

After the switching, new passive application entities 61-2, 61-2 are started by the application placement device in order to restore the redundancy condition that applied before the defect in the computing node 70-2.

Starting from the currently active configuration 62 (i.e., the configuration 62 shown in FIG. 2a) as well as parameters for the applications and the computing nodes 70-x, the application placement device calculates a new configuration 62 or a new application placement, that makes the fewest possible shifts of application entities 60-x, 61-x necessary.

One solution to the application placement device that requires only a single shift is shown in FIG. 2b. This application placement makes only the shift of the passive application entity 61-3 necessary. The application entity 61-3 is shifted from the computing node 70-3 to the computing node 70-4.

The example was constructed in such a way that at least one application entity 60-x, 61-x must be shifted. The configuration 62 shown in FIG. 2b is therefore the optimal configuration 62 with regard to the optimization objective of the application placement device of having to shift as few application entities 60-x, 61-x as possible.

In addition to this solution, there are many other valid solutions. However, these do not realize the optimization objective and are therefore not regarded as optimal solutions. In FIG. 2c, a configuration 62 of such a non-optimal solution is shown by way of example, for which five shifts are needed.

If there are not enough resources (computing nodes, computing power and memory, etc.), the application placement device can also stop application entities 60-x, 61-x. Below two embodiments of the method and the device that can provide solutions in the case of limited resources are described.

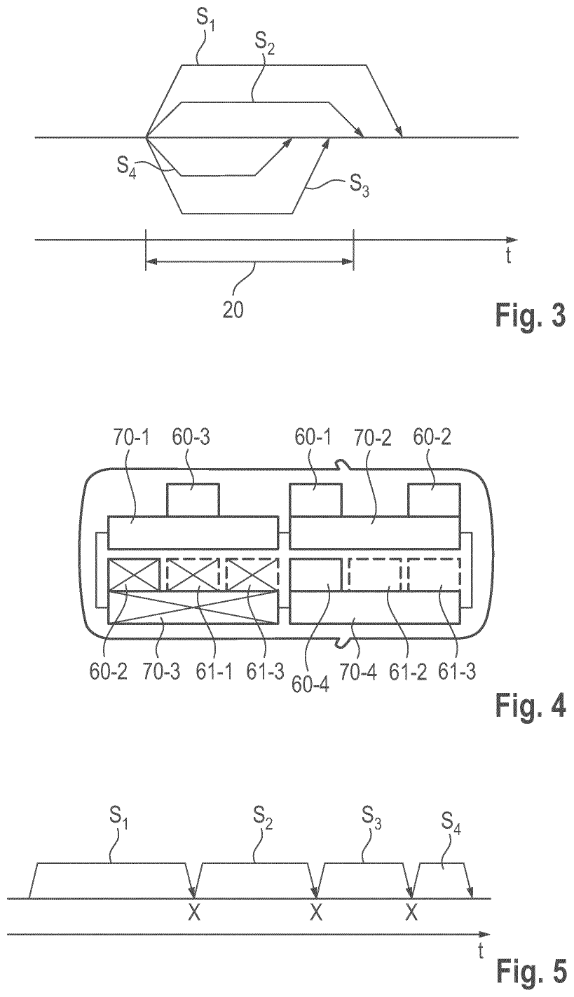

FIG. 3 shows a schematic representation of an embodiment of the method. In the embodiment it is provided that a priority class has been or is assigned to each of the application entities. In the above example with the four applications, the following priority classes are assumed for the sake of clarity:

### Application 1: LOW

### Application 2: HIGHEST

### Application 3: HIGH

### Application 4: HIGH

For reconfiguration, configurations for subsets that are formed or were formed from application entities of at least one of the assigned priority classes are each calculated individually. It is also provided that the subsets are formed in such a way that the subsets step-by-step include only application entities whose assigned priority classes reach a respective minimum priority class. For example, the following subsets S₁, S₂, S₃, S₄ result:

S₁=HÖCHSTE ∪ HOCH ∪ GERING ∪ GERINGSTE,

S₂=HÖCHSTE ∪ HOCH ∪ GERING,

S₃=HÖCHSTE ∪ HOCH,

S₄=HÖCHSTE.

S₁=HIGHEST u HIGH u LOW u LOWEST,

S₂=HIGHEST u HIGH u LOW

S₃=HIGHEST u HIGH

S₄=HIGHEST.

For the calculation, it is then provided that the configurations for the subsets S₁, S₂, S₃, S₄ are calculated in parallel to one another, i.e. simultaneously by means of calculation threads executed in parallel with one another, by means of the application placement device, as shown schematically in FIG. 3, wherein the calculation threads are illustrated over time t. The application placement device then selects the best or most optimal from the calculated configurations.

In some examples, for the calculation to be aborted when a predefined maximum calculation time 20 is reached or exceeded, the already calculated configuration being selected for reconfiguration which includes application entities with the largest number of highest priority classes in each case. In this way, the reconfiguration or the calculation can be controlled in particular in time-critical situations.

If a maximum calculation time 20 is provided, then there would only be configurations for subsets S₃ and S₄, whereas the maximum calculation time 20 would not have been sufficient for subsets S₁ and S₂.

On the basis of the configuration 62 shown in FIG. 2a, it is now assumed that it is not the computing node 70-2 that fails, but rather the computing node 70-3. As a result, not all application entities 60-x, 61-x that were executed before the defect occurred can be distributed to the remaining computing nodes 70-1, 70-2, 70-4, since some boundary conditions (see above) are not fulfilled. With the priority classes defined above, however, at least one configuration 62 or an application placement can be calculated that takes into account the applications or application entities 60-x, 61-x to which the priority classes HIGH and HIGHEST are assigned. FIG. 4 shows a resulting configuration 62.

In FIG. 5 a schematic representation of an embodiment of the method is shown. In principle, the embodiment is designed like the embodiment described above in connection with FIGS. 3 and 4. However, it is provided that the configurations 62 for the subsets S₁, S₂, S₃, S 4 are calculated sequentially by means of the application placement device. This has the advantage that full computing power can be provided when calculating a configuration for a subset S₁, S₂, S₃, S₄. It is further provided here that the configurations 62 are first calculated for those subsets that each comprise the largest number of highest priority classes, i.e. in the example according to the sequence: S₁, S₂, S₃, S₄.

In particular, it is provided that the calculation is continued only if a previous calculation was unsuccessful or did not lead to a solution or configuration 62 (indicated in FIG. 4 by an “X”). In the example shown, only a solution or a configuration 62 would be found for the subset S₄, i.e. it only an application placement or a configuration 62 can be calculated in which the applications with the HIGHEST priority class are taken into account.

### LIST OF REFERENCE SYMBOLS

1 device
2 monitor device
3 switching device
4 application placement device
5 fail-safe device
10 sensor data
11 redundancy condition
12 segregation condition
20 maximum calculation time
30 Control signals
50 vehicle
51 sensor
52 actuator
60, 60-x application entity (active)
61, 61-x application entity (passive)
62 configuration
63 switching signal
70-x computing node
Sₓ subset
t time

1-10. (canceled)

11. A method for reconfiguring an autonomous vehicle in the event of a fault, comprising:
receiving sensor data in a plurality of application entities;
generating control signals in the application entities for controlling the vehicle, based on the received sensor data;
detecting, via a monitoring device, that the fault is present in one or more of the application entities, operating system and/or hardware corresponding to computer nodes;
isolating the fault, via a switching device, by switching at least one of the plurality of application entities to one or more redundant application entities; and
restoring predetermined redundancy conditions and/or segregation conditions for the plurality of application entities by reconfiguring a configuration via an application placement device,
wherein the reconfiguring comprises minimizing a number of shifts necessary to restore the predetermined redundancy conditions and/or segregation conditions from application entities to other computing nodes.

12. The method according to claim 11, further comprising assigning a priority class to the application entities comprising configurations for subsets of application entities, wherein at least one of the assigned priority classes are determined individually.

13. The method according to claim 12, wherein the subsets are configured such that the subsets successively include only application entities whose assigned priority classes reach a respective minimum priority class.

14. The method according to claim 12, wherein configurations for the subsets are calculated at least partially parallel to one another via the application placement device.

15. The method according to claim 12, wherein configurations for the subsets are at least partially calculated sequentially via the application placement device.

16. The method according to claim 15, wherein the configurations are calculated first for those subsets comprising the largest number of highest priority classes.

17. The method according to claim 14, wherein the calculation is aborted when a predetermined maximum calculation time is reached or exceeded, and a configuration already calculated is selected for reconfiguration, based on application entities having the largest number of highest priority classes.

18. An apparatus for reconfiguring an autonomous vehicle in the event of a fault, comprising:
a plurality of application entities for receiving sensor data and generating control signals for controlling the vehicle, based on the received sensor data;
a monitoring device for detecting that the fault is present in one or more of the application entities, operating system and/or hardware corresponding to computer nodes;
a switching device for isolating the fault by switching at least one of the plurality of application entities to one or more redundant application entities; and
an application placement device for restoring predetermined redundancy conditions and/or segregation conditions for the plurality of application entities by reconfiguring a configuration, wherein the application placement device is configured to reconfigure the configuration by minimizing a number of shifts necessary to restore the predetermined redundancy conditions and/or segregation conditions from application entities to other computing nodes.

19. The apparatus according to claim 18, wherein the application placement device is configured to assign a priority class to the application entities by configuring configurations for subsets of application entities, wherein at least one of the assigned priority classes are determined individually.

20. The apparatus according to claim 19, wherein the subsets are configured such that the subsets successively include only application entities whose assigned priority classes reach a respective minimum priority class.

21. The apparatus according to claim 19, wherein configurations for the subsets are calculated at least partially parallel to one another via the application placement device.

22. The apparatus according to claim 19, wherein configurations for the subsets are at least partially calculated sequentially via the application placement device.

23. The apparatus according to claim 22, wherein the configurations are calculated first for those subsets comprising the largest number of highest priority classes.

24. The apparatus according to claim 21, wherein the calculation is aborted when a predetermined maximum calculation time is reached or exceeded, and a configuration already calculated is selected for reconfiguration, based on application entities having the largest number of highest priority classes.

25. A method for reconfiguring an autonomous vehicle in the event of a fault, comprising:
receiving sensor data in a plurality of application entities;
generating control signals in the application entities for controlling the vehicle, based on the received sensor data;
detecting, via a monitoring device, that the fault is present in one or more of the application entities, operating system and/or hardware corresponding to computer nodes;
isolating the fault, via a switching device, by switching at least one of the plurality of application entities to one or more redundant application entities;
restoring predetermined redundancy conditions and/or segregation conditions for the plurality of application entities by reconfiguring a configuration via an application placement device, wherein the reconfiguring comprises minimizing a number of shifts necessary to restore the predetermined redundancy conditions and/or segregation conditions from application entities to other computing nodes; and
assigning a priority class to the application entities comprising configurations for subsets of application entities, wherein at least one of the assigned priority classes are determined individually.

26. The method according to claim 25, wherein the subsets are configured such that the subsets successively include only application entities whose assigned priority classes reach a respective minimum priority class.

27. The method according to claim 25, wherein configurations for the subsets are calculated at least partially parallel to one another via the application placement device.

28. The method according to claim 25, wherein configurations for the subsets are at least partially calculated sequentially via the application placement device.

29. The method according to claim 28, wherein the configurations are calculated first for those subsets comprising the largest number of highest priority classes.

30. The method according to claim 27, wherein the calculation is aborted when a predetermined maximum calculation time is reached or exceeded, and a configuration already calculated is selected for reconfiguration, based on application entities having the largest number of highest priority classes.
